(19) United States
(12) Patent Application Publication
(10) Pub. No.: US 2006/0190347 A1
(43) Pub. Date: Aug. 24, 2006

(54) System and process for sales, validation, rewards and delivery of prepaid debit cards

(76) Inventor: Vincent Cuervo, Coral Gables, FL (US)

Correspondence Address: VINCENT CUERVO, 1545 MILLER ROAD, CORAL GABLES, FL, 33146, US

(21) Appl. No.: 11/344,644

(22) Filed: Feb. 1, 2006

Related U.S. Application Data
(63) Continuation-in-part of application No. 10/342,991, filed on Jan. 15, 2003.
Application No. 10/342,991 is a continuation-in-part of application No. 10/114,522, filed on Apr. 2, 2002, now abandoned.
Application No. 10/114,522 is a continuation-in-part of application No. 09/894,581, filed on Jun. 28, 2001, now abandoned.
Application No. 09/894,581 is a continuation-in-part of application No. 09/524,496, filed on Mar. 13, 2000, now Pat. No. 6,405,182.
Application No. 09/524,496 is a continuation-in-part of application No. 09/207,854, filed on Dec. 8, 1998.
Application No. 09/207,854 is a continuation-in-part of application No. 09/128,088, filed on Aug. 3, 1998, now Pat. No. 6,105,009.
Application No. 09/128,088 is a continuation-in-part of application No. 08/877,006, filed on Jun. 16, 1997, now abandoned.

(51) Int. Cl. G06Q 30/00

(52) U.S. Cl. 705/26

(57) ABSTRACT

Systems and Processes allow for sales, validation, rewards and dispense of prepaid debit cards and the like, which may have multiple personalities and may be offer and market under a vast plurality of names. Said prepaid debit card is prepaid with the monetary value loaded on the card on fixed amounts or variable desired amounts, and the payment mode use of cash and/or the amount charged to another bank card (credit, debit, bank card, ATM, checks, and the like). Deliver only after a validation signal authorizes such deliver at point of sales or cash registers location at retail stores, services providers, businesses or entities, through the U.S. Postal Service, overnight facilities or by Automated Teller Machines with dispensing debit card feature. The said prepaid debit card is not linked to bank accounts or any other bank equity instrument, retailers, banks as well as other institutions, associations or entities may become issuers after been licensed.

### CROSS REFERENCE

The present application is a continuation in part of U.S. application Ser. No. 10/342,991 filed Jan. 15, 2003; which is a continuation in part of U.S. application Ser. No. 10/114,522 filed Apr. 2, 2002 now abandoned, which is a continuation in part of application Ser. No. 09/894,581 filed on Jun. 28, 2001 now abandoned, which in turn is a continuation in part of application Ser. No. 09/524,496 filed Mar. 13, 2000 (now U.S. Pat. No. 6,405,182), which is a continuation in part of application Ser. No. 09/207,854 filed Dec. 8, 1998 which is a continuation in part of application Ser. No. 09/128,088 filed Aug. 3, 1998 (now U.S. Pat. No. 6,105,009) which is a continuation in part of application Ser. No. 08/877,006 filed on Jun. 16, 1997 and now abandoned. These applications are incorporated here by reference in their entirely.

### BACKGROUND OF THE INVENTION

The present invention relates to systems and processes for sales, validation, gifts, rewards and delivery of prepaid debit cards and the like.

The prior art include systems and processes for activation, and deliver and/or dispense of debit cards, with an example including telephone debit cards. These known processes and systems, however, are generally complicated, costly and otherwise cumbersome. Additionally, they often do not provide acceptable levels of security and flexibility. Accordingly, a number of needs are unresolved in the art.

### SUMMARY OF THE INVENTION

One embodiment of the present invention is a process for sales, validating, delivering or handing over prepaid debit cards, having them presently multiple personalities and been marketed under a plurality of names as, Payroll Cards, Gift Cards, Health Savings Cards, Cash Cards, ATMs Cards, Speedway Cards, Debit Cards for Child Support payments and the like, compressing the steps of receiving from purchaser/user particulars data and transactions particulars data with a first computer, storing the purchaser/user user particulars data and transactions particulars data in a first computer memory, and receiving finds. As the card is prepaid with the loaded monetary value stored on the card. Licensed retailers, employers or entities acting as issuers and/or distributors may offer and sell prepaid debit card marketed and/or named prepaid gift cards, prepaid payroll cards, and the like to selected users, said retailers funding their gift cards becoming fund depositories, and said employers or entities having finds to be dispersed onto these cards, decreasing payroll distribution costs, easing bank reconciliation, reducing fraud and eliminating check cancellation, loading the debit cards with the employees salaries, salesmen commissions, service providers billings, and the like. All authorizing, and determining prepaid debit card line of credit or the loaded monetary value stored on the debit card that do not carry value until it is validated. The exemplary process and system further includes steps of computing a line of credit, using the first computer to validate the funds and generate a validation. The line of credit or loaded monetary value is stored in the first computer memory. A prepaid debit card having a unique identifier number is deliver, dispense or hand over only after the validation signal is communicated from the first computer, and the unique identifier communicated back to the first computer.

### ESPECIFICATIONS

The present invention relates to systems and processes for the sale, validation, rewards, gifts, and deliver or dispense of prepaid debit cards. A retailer, business, employer or entity may offer to purchasers, employees or users the sale of prepaid debit cards, once funded and validated before it is deliver, dispense or hand out to them the prepaid debit cards under a plurality of names and marketed presently by businesses or entities as Payroll Prepaid Debit, ATMs Prepaid Debit Cards, and the like and mostly marketed by retailers as Prepaid Gift Debit Cards, and other current names like Debit Cash Cards, Debit Speedway Cards, Prepaid Health Savings Debit Cards, and the like. The card is prepaid with the monetary value loaded on the card, offered in fix and/or different and variable amounts of prepaid values and lines of credit for purchasers/users, employers, retailers, entities, merchants and users need or request. When purchaser/user provide to issuer or provider at the point of sales terminals, cash registers, Automated Teller Machines, and the like locations, the personal data required, the prepaid monetary value to be loaded on the card, the credit instrument use, the payment mode for the prepaid debit card to be used may be cash and or the amount charged to another bank card (credit/debit card, ATM Card, checking, and the like) and its data is revised for possible bad check rejection, counterfeit bills, or insufficient funds in such equity credit instrument. The issuer or provider deliver to purchaser the prepaid debit card and serial number after the line of credit or monetary value to load on the card has received approval as requested and including the guidance purchaser should follow after card validation, as may be: confidential PIN or ID number to be used with the card after it is received; purchaser/user special deliver or hand over preference; if billing and residence address are the same, and any additional necessary information. Ounce, after all data receives approval it should be when issuer, provider or the like should proceed with validation.

The card stores and transfers money and may be used to facilitate plurality of transactions:

a) Payroll: Prepaid debit cards may be issued by employers, entities or corporations, and their finds may be dispersed onto the prepaid cards replacing traditional paper based checks, reducing their costs, paperwork, fraud and other inconveniences, those funds are from amounts or payments due to their employees, associates, salesmen, rebates salaries, commissions, bonuses, and the like are on the card delivered or hand out and available to obtain cash and can be recharged;

b) Gift: Prepaid debit cards may be issue by retailers, stores, entities and cards associations or services providers, as prepaid gift cards, as rewards or incentives, for products and stores promotional purposes.

c) Funds Transfer: Individuals may transfer funds from one card to another, Electronic Funds Transfer (EFT), or replenish a card in real time. The user may go to local ATMs and obtain cash, buy theater tickets, or buy debit cards (See inventor's U.S. Pat. No. 6,105,009);

Prepaid debit cards could be issued by licensed businesses, entities, retailers or group of retailers supplying information of sales and delivered by merchants at their stores, kiosks, postal services, or other facilities.

Prepaid debit cards may be issued by licensed credit-debit card chains, corporations or associations for sales or distribution at stores or service providers where their other credit instruments are accepted. May be issued by employers, corporations, business entities when dispersing employees funds, salaries, commissions or payments due to service providers and the like to prepaid debit cards decreasing with the use of these payrolls or payments distribution costs.

The present invention relates to a system and process for sales and purchase orders and, more specifically, to a system and process for the sale, purchase, validation and deliver or hand over of prepaid debit cards. The system and process of the invention would have applications on current communications systems such as e-mails, wireless phones, telephone voice and other electronic facilities. Said prepaid debit card is not necessary linked to a bank checking account or any other credit equity instrument.

### BRIEF DESCRIPTION OF THE DRAWINGS

FIG. 1 is a schematic useful describing an exemplary embodiment of the present invention.

FIG. 2 is a flow chart summarizing the process steps of an exemplary process of the invention.

### DETAILED DESCRIPTION OF THE PREFERRED EMBODIMENTS

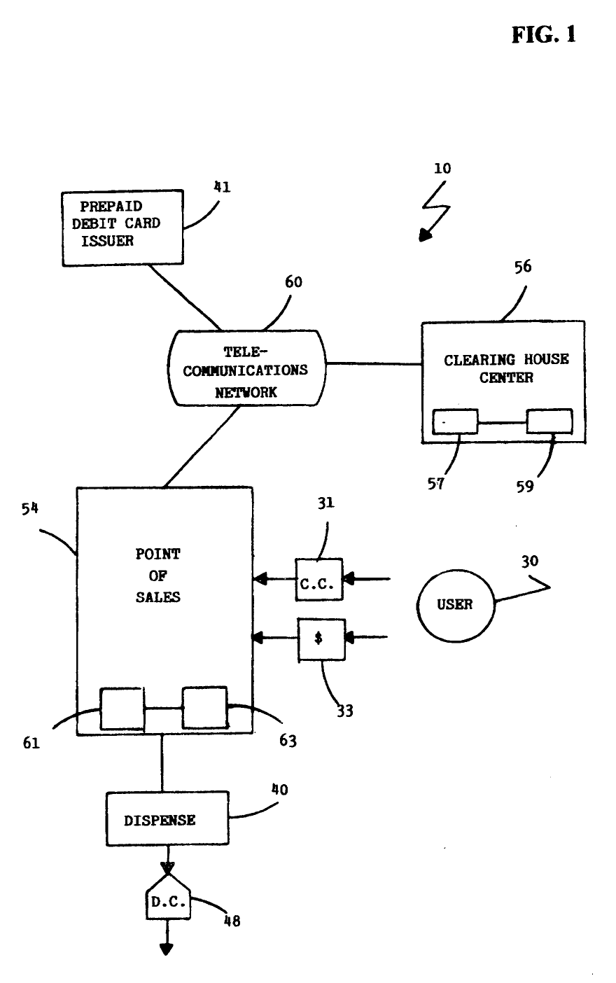

Referring now to the drawings, a system embodiment of the present invention is generally referred to with numeral 10 in FIG. 1. It will be appreciated that the present invention includes processes as well as systems, and that in the descriptions of a system of the invention such as 10 a description of a process may likewise be presented. For example, it will be appreciated that the system 10 of the invention may carry out a process of the invention. The system 10 includes a point of sales terminal location (POS) 54 that may be an ATM, a cash register machine or the like, and may have input and output hardware such as a bill acceptance port, a credit/debit card charge assembly, a keypad, and the like. POS terminal 54 are generally available in retail outlets and for practical reasons are located mostly at counter where transactions for purchases and payments are conducted. It will be appreciated that a merchant using a cash register device or the like may also function as the POS 54. A purchaser 30 has a credit card, or other credit instrument 31 and/or currency 33. A delivery or hand over place is shown at 40 and a card issuer at 41. The card issuer 41 may be the issuer of he debit card 48 and/or the credit card 31. The deliver or hand over 40 may be a merchant such as a clerk or cashier, an issuer employee, an entity or place selling the cards, at a business delivering or distributing the cards to its employees, workers, salesmen or creditors, an automated teller machine (ATM), (U.S. Pat. No. 6,105,009, “Automated Teller Machine Dispenser of Debit Cards”), or the like. It may be a part of the POS or may be separated there from. The deliver or dispenser can have sufficient amounts of debit cards 48 that each has a unique identifier such as a digital storage number or the like. A clearinghouse 56 is connected to a telecommunications network 60, which is also connected to the card issuer 41 and the POS 54. The clearinghouse 56 has a computer 57 with an associated storage or memory 59. The POS 54 also has a computer 61 with an associated storage or memory 63.

As shown in FIG. 1, a card purchaser 30 initiates a process of the invention when approaching a merchant offering the sale of prepaid debit cards through a POS 54. The purchaser 30 can be an individual or an entity or business purchasing prepaid debit cards for various users as employees, workers, salesmen and the like. Once the purchaser 30 determines a prepaid amount to be purchased and credited or the monetary value to load on the prepaid debit card(s) 48, the user's(s′) particulars are entered to the computer 61. The particulars may include, for instance, one or more of his name, address, social security number, a personal identification number (“PIN”), mothers maiden name, for security reasons, and the like. The particulars may be obviated under certain circumstances (e.g., use of a bearer debit card). The issuer 41 determines the amount of particulars required, and may considered issuers of flexibility for the purchaser in terms of how much information wants to disclose. Generally, the more information that is disclosed, the more secure the debit card 48 will be. Optionally, a second PIN number may be used for additional security. The information entered by the debit card purchaser 30 is stored in storage assembly 63 by the computer assembly 61 for consequent transmission to clearinghouse 56.

A line of credit is computed and stored in the storage means 63. The computer 61 generates a validation signal, which is communicated from the POS terminal location 54 to the deliver 40. After receiving the validation signal, the deliver 40 may deliver the prepaid debit card 48. The unique identifier for the debit card 48 is communicated to the computer 61. If the user 30 has requested, a plurality of debit cards 48 may be delivered, and the unique identifier for each of the plurality communicated to the computer 61. The computer 61 assembles a block of information for transmission, including the user(s) particulars data, the transaction particulars data, and the debit card 48 unique identifier(s), and the like. This block of information may be then communicated over the communications network 60 to the clearinghouse 56, where it is received and processed by the second computer 57 and stored on the storage 59 along with the line of credit.

The following example will be helpful in further illustrating the invention. For cash transactions, a merchant may collect the cash 33 from user 30 as if it were for purchase of merchandise, services or similar routine transaction. The merchant will enter the debit card 48 unique identifier, such as an issuing bank's ID number, to the computer 61 for a “virgin” (i.e., un-validated) debit card 48 for the monetary amount of money 33 to load on the debit card. Once this data has been entered to the computer 61, it is stored on the storage 63, and a line of credit is calculated. A validation signal is generated, and the merchant or issuer delivers the debit card 48. The merchant or issuer may also charge a small processing fee.

If more than one card 48 is delivered to the same purchaser 30, then the unique identifiers such as serial numbers for each card 48 may or may not be linked to each other, one linked to each other with the result that all the plurality of cards 48 are associated with the same line of credit. This may be desirable, for instances, so that the card purchaser 48 can obtain a plurality of cards 48 and distribute them to others, with examples including a traveling salesman, a child in college or other family member away from home, who will then be able to use the debit card 48 within the available line of credit. When the unique identifiers such as serial numbers for each card 48 will not be linked to each other the plurality of cards 48 distributed would be associated with the same purchaser/employer having finds representing salaries, commissions, and the like of its employees dispersed onto those cards 48 and with these plurality of debit cards having numerous different lines of credit for the users of debit card 48 who will then be able to use of the debit card 48 within the available line of credit. The card purchaser 30 can then reload the debit card for the others' remote usage, thus effectively constituting and instantaneous transfer of funds.

In another aspect of the present invention, a card issuer 41 may offer rewards or incentives to the purchaser 30 to encourage or to discourage use of the debit card 48. For example, a card issuer 41 may offer rewards or incentives to a user to use the debit card 48 in a specified geographic area. By way of additional example, a card issuer 41 may offer to provide interest payments on a deposited line of credit, or may provide a reward or incentive to use a line of credit after determining that it has been unused for a period of time.

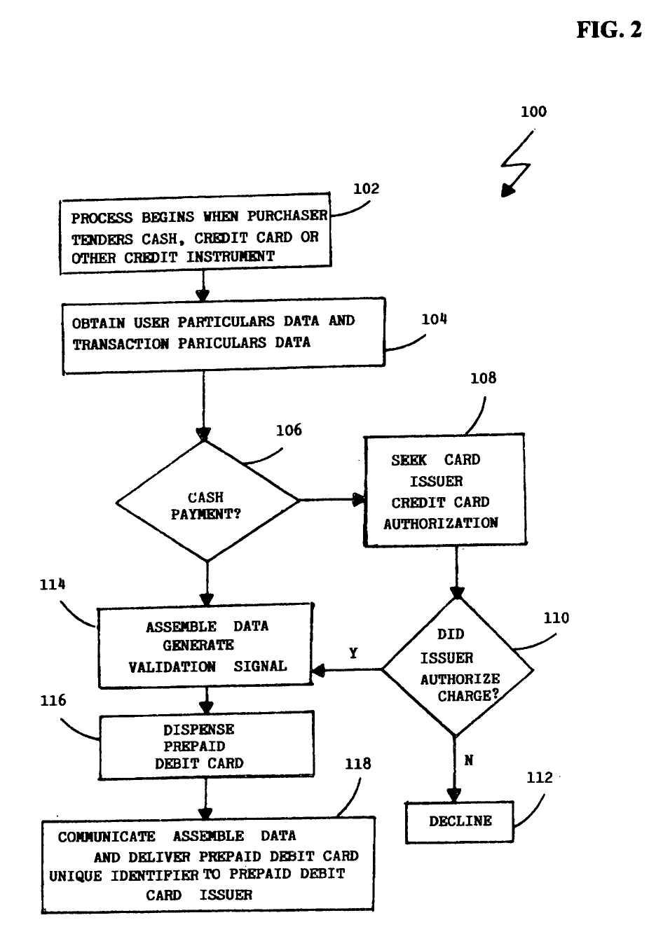

FIG. 2 is a flowchart illustrating steps of an additional exemplary invention embodiment 100. It will be appreciated that the steps of the process 100 may be carried out using the system 10 of FIG. 1, or another system. The process 100 begins when a purchaser begins a transaction by tendering cash, other equity credit instrument, or a credit card (BLOCK 102). User particulars are then obtained (block 104). Obtaining user particulars may include, for instance, oral communication with the customer, entry by the customer of data into POS terminal 54 or the like, or through communication with a credit card issuer after obtaining a credit card. A determination is made whether cash or credit card has been tendered (block 106). If a credit card, the computer communicates with a card issuer to obtain authorization (block 108). If the issuer of credit card doesn't authorize the charge, the computer declines the transaction (blocks 110 and 112).

If the tendered funds were cash or if the credit card issuer granted authorization, data is assembled and a validation signal generated (block 114). The assembled data may include, but not limited to, user and transactions particulars. Finally, a debit card is dispensed (block 116). The assembled data and the unique identifier for the dispensed debit card are communicated to the debit card issuer (block 118).

Those skilled in the art will appreciate that the exemplary aspects of invention embodiments discussed herein are for illustration purposes only, and that the invention is not limited to these exemplary aspects.

1. A system and process for selling, validating rewarding, delivering or dispensing prepaid debit cards directly to buyers at a point of sales or cash register locations or World Wide Web (Internet) comprising the steps of:
receiving user particulars data and transaction particulars data with a first computer, said first computer having a memory and being at the point of sale locations;
storing said user particular data and said transaction particulars data in said first computer memory at the point of sale locations;
receiving funds;
validating said finds with said first computer located at the point of sale;
computing a line of credit and storing said line of credit in said first computer memory at the point of sale location;
generating a validation signal with said first computer;
dispensing or handing over at least one prepaid debit card only after said validation signal is communicated from said first computer, said prepaid debit card having a unique identifier;
communicating said prepaid debit card unique identifier to said first computer;
assembling a block of information with said first computer, said block of information including at least said purchaser/user particulars data, said transactions particulars data, and said prepaid debit card unique identifier, and
communicating said block of information directly from said first computer to a second computer over a communications network that links said first computer to said second computer, said second computer having a memory, and storing said block of information in said second computer memory.

2. A process as defined by claim 1 wherein said block of information includes the prepaid monetary value to be loaded on the prepaid debit card or said line of credit, and the payment mode for the prepaid debit card may be the using of cash, and/or the amount to be charged to another bank card (credit/debit card, ATM Card, checking, and the like) and data may be revised for possible bad check rejection, counterfeit bills, or insufficient funds in such equity credit instrument.
Payment for the monetary amount loaded on the prepaid debit card can be made through Electronic Funds Transfer (EFT), to determine/issuer (merchant, employer, and the like) or to the finds depositary if different, through out point of sales or cash register devices, Automated Teller Machines, and the like. Also throughout wireless phone, e-mail, PC, and the WWW (Internet)/E-Commercial.

3. A process as defined by claim 1 wherein said first computer is contained in a point of sale or cash register devices having a bill acceptance port, a credit/debit card charge assembly, sufficient available amount of rechargeable debit cards offering a plurality of available cards with fixed and variable values amounts offered to users and deliver facilities by merchant, clerk or employee of issuer to purchaser/user. Available blank debit cards for purchaser/user(s) choice in determining the desired monetary value or line of credit amount to be loaded. Said prepaid debit cards having a unique identifier.

4. A process as defined by claim 1 wherein the step of receiving user particulars data and transactions data comprises obtaining data from a purchase/user credit card or other credit instrument and communicating with issuer over said communications network to obtain user particulars data, wherein the step of receiving finds comprises the communicating with the credit card or credit instrument issuer over said communications network to obtain issuer authorization to charge the credit card or credit instrument been used.

5. A process as defined by claim 1 wherein said purchaser/user particulars data may include at least a first and second personal identification number.

6. A process as defined by claim 1 wherein said means for dispensing comprises a merchant, retailer, employer, individual, clerk, or employee that may hand over or deliver the prepaid debit card, and having access to a plurality of un-validated prepaid debit cards, with fixed and/or blank amounts having each a unique identifier, and being separate from said first computer. Issuer my request purchaser/user it's preference as to the dispense or deliver to be by hand over, through the U.S. Postal Service, overnight service facilities, and if available, through deployed ATMs with dispensing prepaid debit cards features as described in U.S. Pat. No. 6,105,009.

7. A process as defined by claim 1, permits monetary value loaded on the prepaid debit card to may be used by owner/user at PIN-based merchants locations or where mayor cards are use and accepted permitting the user of the debit card to pay for services, merchandise purchases, online bills payment, receive tax refunds, funds transfers, worldwide ATMs withdrawals and the like. Said debit card may be recharged as frequent as needed when authorized by issuer, and my be up to the issuer the charge of reloading fee each time and for the amount of each re-load. Issuers of the debit cards may charge, if allowed and disclosed to purchasers/users, fees for purchase and use of the prepaid debit cards.

8. A process as defined by claim 1, may allow licensed employers, businesses or corporations to facilitate their employees, associates, creditors and the like access to their wages, commissions, incentives, bonuses, rewards and the like through prepaid debit cards facilitating employers replacement of costly paper checks, issuing to employees, salesmen or associates a rechargeable prepaid debit cards enabling the recipients merchandise purchases, bills and services payments, cash withdraws at ATMs, point of sales and cash register devices locations as a debit card.

9. A system and process as defined by claim 1 provides the selling, validating, rewarding, delivering or dispensing a prepaid debit cards comprising the steps of;
facilitates licensed retailers, stores, financial institutions, entities, employers, and service providers the issue of prepaid debit card, its sales and deliver to purchasers prepaid debit cards at point of sales, cash register, ATMs devices and the like, at retail stores, kiosks, or services providers in communication with a remote clearinghouse computer, each POS or cash register terminals including:
a keypad with numbers, letters, a cash drawer and a means for entering data from a credit card to tender transactions, the POS or register devices being operated by a merchant, employer, store clerk or employee who normally tender transactions and dispensation of cards marketed as prepaid debit cards and others, currently using a multiple plurality of names;
the system also including a plurality of un-validated or “virgin” debit cards each containing a unique card ID number, at the point of sales or cash registers terminals locations, at one or at all multiple store and/or issuers' locations collecting and storing ID numbers and particulars data and said transaction particulars including a variable and rechargeable line of credit or the amount of the prepaid monetary value loaded on the card that may be associated with promotional sales of prepaid debit cards;
the point of sale or the cash register devices forming a block of data containing the particulars of the transaction and the ID of the particular card forwarding this block of data to the clearinghouse computer;
the clearinghouse computer establishing the line of credit or prepaid monetary value from the particular card if the particular card is valid;
the clearinghouse sending verification to the point of sales or a register terminal location causing the terminal to tender the transaction and collect finds to cover the line of credit associated with the particular prepaid debit card;
the particular prepaid debit card then being dispensed, delivered or hand over after validation signal is received at the point of sale or cash register device terminals or other locations with an associated variable and/or optional and rechargeable line of credit;
the prepaid debit card subsequently being accepted by merchant, clerk or employee tender for transactions; the clearinghouse computer being able to affect the line of credit for the particular prepaid debit card upon passage of time with unused balances.

10. A process as defined in claim 1 for delivering or dispensing prepaid debit cards at a point of sales or cash register locations comprising the steps of:
receiving purchaser particulars data and transaction detailed data, with a first computer, said first computer having a memory and being located at the point of sales or cash register locations and having a memory, a data input for inputting said user data;
storing said user particular data and said transaction particulars data in said first computer memory;
receiving funds and using said first computer to validated said funds;
computing a line of credit and storing said line of credit in said first computer memory;
generating a validation signal with said first computer;
dispensing a prepaid debit card with means for dispensing only after said validation signal is communicated from said first computer, said debit card having a unique identifier;
communicating said debit card unique identifier to said first computer;
assembling a block of information with said first computer, said block of information including at least said user particulars data, said transaction particulars data, and said debit card unique identifier;
communicating said block of information directly from said first computer to a second computer over a communications network that links said first computer to said second computer, said second computer having a memory; and
storing said block of information in said second computer memory.

11. A process as defined by claim 10 wherein said first computer is contained in a point of sale, cash register terminals and/or the like locations, or online WWW (Internet) having a bill acceptance port and a credit/debit card charge assembly.

12. A process as defined by claim 10 wherein said means for dispensing or handing over is separate from said first computer having an available amount of plurality of un-validated or “virgin” debit cards.

13. A process as defined by claim 1 wherein said means for dispensing comprises a merchant, retailer, employer, individual, clerk, or employee that may hand over or deliver the prepaid debit card, and having access to a plurality of un-validated (“virgin”) debit cards, with fixed and/or blank amounts having each a unique identifier, and being separate from said first computer. Issuer my request purchaser/user it's preference as to the dispense or deliver to be by hand over, at POS, cash registers, through the U.S. Postal Service, overnight service facilities, and if available, through deployed ATMs with dispensing prepaid debit cards features as described in U.S. Pat. No. 6,105,009.

14. A process as defined by claim 10 and further including the step of a card issuer providing at least on incentive for a debit card user to use said prepaid debit card, said at least one incentive determined using said second computer.

15. A process as defined by claim 14 wherein said at least one incentive comprises encouraging use of the prepaid debit card and is applied after determining that the card has been unused for a period of time.

16. A process for selling, validating and dispensing a prepaid debit card as defined in claim 1, and further including the step of subtracting from said line of credit a small processing fee at the point of sale or cash register, said processing fee being paid or credited to the merchant handling over or dispensing said prepaid debit card and not to the issuer of said card.

17. A process as defined by claim 1 for dispensing prepaid debit cards to purchasers/users at a point of sale, cash register devices, ATMs, terminals locations, and online through the WWW (Internet) comprising the steps of:
receiving purchasers/users particulars data and transaction particulars data with first computer, said first computer having a memory and being located at the point of sale, cash register location or online (Internet);
storing said users particulars data and said transaction particulars data in said first computer memory;
receiving finds;
validating said funds with said first computer;
computing a line of credit or the monetary funds to be loaded on card and storing said line of credit in said first computer memory;
generating a validation signal with said first computer;
delivering a plurality of prepaid debit cards each having a unique card identifier only after said validation signal is communicated from said first computer,
communicating said plurality of unique prepaid debit card identifiers to said first computer, and,
associating said plurality of unique prepaid debit card identifiers with said line of credit whereby each of said plurality of prepaid debit cards may be used to access said line of credit or monetary funds loaded on card.

18. A process as defined by claim 17 wherein said first computer is contained in a point of sale terminal or cash register terminals and online WWW (Internet) having a bill acceptance port and a credit/debit card charge assembly.

19. A process as defined by claim 17 wherein said means for selling, delivering and validating directly to purchasers/users has available a numerous plurality of said rechargeable un-validated (“virgin”) prepaid debit cards of determined fix amounts and blanks or non-determined amounts.

20. A process as defined by claim 1 for selling, rewarding, validation, and dispensing a plurality of prepaid debit cards directly to buyers by retailers point of sales terminals, cash register devices, or online personal computer (PC) online through the WWW (Internet), comprising the steps of:
receiving buyers particulars data and transactions particulars data with a first computer, said first computer being located at point of sales terminals and/or the like having a memory, a data input for inputting said user data;
storing said purchasers/users particulars data and transactions particulars data in said first computer memory;
receiving funds;
validating said funds with said first computer;
using said first computer to communicate with a credit card issuer over said communications network to obtain purchasers particulars data and to obtain authorization;
computing each a line of credit and storing said lines of credit in said first computer memory;
generating a validation signal with said first computer;
dispensing a plurality of prepaid debit cards each having a unique card identifier after said validation signal is communicated from said first computer;
communicating said plurality of prepaid debit cards unique identifiers to said first computer; and,
associating said plurality of prepaid debit cards unique identifiers with said line of credit whereby each of said plurality of prepaid debit cards may be used to access said line of credit.
wherein a prepaid debit card issuer provides at least one incentive for using said prepaid debit card determining that said debit card has been unused for a period of time; and
wherein a prepaid debit cards issuer may authorize a fee charge from purchasers/users when the said prepaid debit card is purchased or re-loaded.

20. A process as defined by claim 20 wherein said first computer is contained in a point of sale terminal or cash register terminals and/or personal computer (PC) online on WWW (Internet) having a bill acceptance port and a credit/debit card charge assembly,

21. A process as defined by claim 1 for dispensing, deliver or hand over prepaid debit cards at any of a number of available points of sale or cash register devices terminals and the like, personal computers (PC) and online WWW (Internet) including keypad with numbers and letters and means for entering data from a credit card to tender transactions comprising the steps of:
creating a rechargeable prepaid debit cards not linked to a bank account, said prepaid debit card useable for purchasing merchandise, buying or paying for services or receiving tax refunds and the like;
at some point in the process accepting a credit card or other credit instrument as mode of payment containing purchaser particulars data by a merchant, employer, retailer or entity that sells such prepaid debit cards;
receiving transactions particulars data at the point of sale or cash register terminals, said point of sale or cash register terminal having a memory;
storing said purchaser/user particulars data and said transaction particulars data in said memory;
establishing a line of credit or monetary value to be loaded on the card that is associated with such debit card at a location remote from the point of sale or cash register terminals;
associating a variable or fix line of credit amount determined by prepaid debit card purchaser when determining and requesting the line of credit or the monetary value that wants to be loaded on the debit card;
generating a validation signal indicative of approval of the purchase of the prepaid debit card that is transmitted to the point of sale terminal or cash register locations for visual retrieval by the issuer and/or merchant selling said prepaid debit card;
dispensing at least one prepaid debit card, in the amount of the line of credit, only after said validation signal and verification approval is received by the point of sale terminal attended by merchant, retailer, employee, or clerk of issuer to normally tender store merchandise transactions;
creating, where permissible, a reward or incentive for use of the debit card within a predetermined period of time; and
storing on the prepaid debit card a unique card identification number that can be used to associate the prepaid debit card with the line of credit.

22. A process as defined by claim 20 wherein said first computer is contained in a point of sale terminal, cash register terminals or WWW having a bill acceptance port and a credit/debit card charge assembly.

23. A process for dispensing prepaid debit cards at a point of sale comprising the steps of:
obtaining data from a user credit card or other credit instrument with a first computer, said first computer located at the point of sale and having memory;
obtaining transactions particulars data with first computer;
using said first computer to communicate with a credit card issuer over said communications network to obtain user particulars data and to obtain authorization;
storing said user particulars data and said transaction particulars data in said first computer memory;
computing a line of credit and storing said line of credit in said first computer memory;
generating a validation signal with said first computer;
dispensing at least one prepaid debit card after said validation signal is communicated from said first computer, said prepaid debit card having a unique identifier;
communicating said prepaid debit card unique identifier to said first computer; and
wherein an incentive is applied to use said line of credit after the passage of time with an unused balance.

24. A process for dispensing prepaid debit cards at a point of sale as defined by claim 1 wherein said line of credit is not pre-determined.

25. A process for dispensing debit cards at a point of sale or cash register locations as defined by claim 1 wherein said block of information includes said line of credit or monetary amount load on the prepaid debit card, and wherein said line of credit is unknown to said second computer before the step of communicating said block of information directly from said first computer to said second computer.
